(19) United States
(12) Patent Application Publication
(10) Pub. No.: US 2025/0191577 A1
(43) Pub. Date: Jun. 12, 2025

(54) MODEL TRAINING DEVICE, MODEL TRAINING METHOD AND AUTOMATIC SPEECH RECOGNITION APPARATUS FOR IMPROVING SPEECH RECOGNITION OF NON-NATIVE SPEAKERS

(71) Applicant: KOREA ADVANCED INSTITUTE OF SCIENCE AND TECHNOLOGY, Daejeon (KR)

(72) Inventors: Changdong YOO, Daejeon (KR); Eunseop YOON, Daejeon (KR); Hee Suk YOON, Daejeon (KR)

(21) Appl. No.: 18/969,702

(22) Filed: Dec. 5, 2024

(30) Foreign Application Priority Data
Dec. 7, 2023 (KR) 10-2023-0177087

(51) Int. Cl. G10L 15/06; G10L 15/02; G10L 15/22

(52) U.S. Cl. CPC G10L 15/063; G10L 15/02; G10L 15/22

(57) ABSTRACT

Disclosed is a model training device including: an accent module trained to extract an accent feature from an audio feature of an utterance speech; and a prompt generator for extracting a first accent feature from a prompt concatenation input that concatenates the prompt to the audio feature, and a second accent feature from the audio feature by using the accent module, and being adversarially trained to minimize interdependence between the first accent feature and the second accent feature to generate a prompt from the audio feature.

### CROSS-REFERENCE TO RELATED APPLICATION

This application claims priority to and the benefit of Korean Patent Application No. 10-2023-0177087 filed in the Korean Intellectual Property Office on Dec. 7, 2023, the entire contents of which are incorporated herein by reference.

### BACKGROUND

### (a) Field

The present disclosure relates to a model training device, a model training method, and an automatic speech recognition apparatus for improving speech recognition of non-native speakers.

### (b) Description of the Related Art

Recently, when learning a speech recognition model using large-scale data composed of native speakers' speech, studies showing excellent recognition performance for native speakers' speech have been published.

However, significant recognition performance degradation occurs when speech recognition is performed for non-native speakers' speech using the speech recognition model.

Most of the proposed methods to solve these problems are fine-tuning speech recognition models by using data from non-native speakers to improve their performance.

However, the conventional method for improving the speech recognition performance of non-native speakers' speech requires a lot of cost and has an inefficient problem as the fine-tuning of the model increases in size. In addition, although the performance of non-native speakers' speech is improved after fine-tuning, there is a problem that the performance of native speakers' speech, which was previously excellent, is greatly reduced.

### SUMMARY

The present disclosure attempts to provide a model training device, a model training method, and an automatic speech recognition apparatus for improving speech recognition of non-native speakers, which provide an Information Theoretic Adversarial Prompt Tuning (INTapt) capable of readjusting an attention of a pre-trained speech recognition model without updating backbone weights through prompts concatenated to original inputs similar to native English speech.

An embodiment of the present disclosure provides a model training device operated by at least one processor, the model training device including: an accent module trained to extract an accent feature from an audio feature of an utterance speech; and a prompt generator for extracting a first accent feature from a prompt concatenation input that concatenates the prompt to the audio feature, and a second accent feature from the audio feature by using the accent module, and being adversarially trained to minimize interdependence between the first accent feature and the second accent feature to generate a prompt from the audio feature.

The prompt generator may be trained to minimize a Connectionist Temporary Classification (CTC) loss of a speech recognition model that outputs text from the prompt concatenation input.

The accent module may include: an accent feature extractor that is trained with an accent classification head that isolates an accent feature of a given speech and extracts the accent feature from the audio feature; and an accent intensity regression head for predicting the CTC loss to capture an accent intensity by using the accent feature extracted by the accent feature extractor.

The accent feature extractor may extract the accent feature from a hidden state of the audio feature acquired through the speech recognition model.

The model training device may further include a mutual information neural estimator that estimates the interdependence by using a neural network.

The speech recognition model may be a model trained by using native utterance data, and the utterance speech used for training the accent module and the prompt generator may be a non-native utterance speech.

Another embodiment of the present disclosure provides a method of operating a model training device operated by at least one processor, the method including: training an accent module to extract an accent feature from an audio feature of an utterance speech; extracting a first accent feature from a prompt concatenation input that concatenates the prompt to the audio feature, and a second accent feature from the audio feature by using the accent module; and adversarially training a prompt generator that generates a prompt from the audio feature to minimize interdependence between the first accent feature and the second accent feature.

The method may further include training the prompt generator to minimize a Connectionist Temporary Classification (CTC) loss of a speech recognition model that outputs text from the prompt concatenation input.

The training of the prompt generator may include: obtaining a hidden state by inputting the audio feature into the speech recognition model; obtaining the prompt by inputting the hidden state into the prompt generator; generating the prompt concatenation input by concatenating the audio feature and the prompt; inputting the prompt concatenation input into the speech recognition model to obtain the CTC loss; and training the prompt generator to minimize the CTC loss.

The extracting may include: obtaining a first hidden state by inputting the prompt concatenation input to the speech recognition model, and obtaining a second hidden state by inputting the audio feature to the speech recognition model; and extracting the first accent feature by inputting the first hidden state into the accent module, and extracting the second accent feature by inputting the second hidden state into the accent module.

The adversarially training may include measuring the interdependence by using a mutual information neural estimator based on a neural network model.

The training of the accent module may include: training the accent module to extract an accent feature from the hidden state of the audio feature acquired through the speech recognition model, and to predict the CTC loss using the extracted accent feature and capture the accent strength; and train the accent module to extract the accent feature from the audio feature by being trained with an accent classification head that isolates the accent feature of a given speech.

Still embodiment of the present disclosure provides an automatic speech recognition apparatus operated by at least one processor, the automatic speech recognition apparatus including: a prompt generator for generating a prompt from an accent feature, which is a state hidden in an audio feature of an utterance speech; and a voice model for generating text for the utterance speech from a prompt concatenation input that concatenates the audio feature and the prompt.

The prompt generator may be adversarially trained to minimize interdependence between a first accent feature extracted from the prompt concatenation input that concatenates the prompt to the audio feature of the utterance speech and a second accent feature extracted from the audio feature.

The prompt generator may be trained to minimize Connectionist Temporal Classification (CTC) loss of a speech recognition model that outputs text from the prompt concatenation input.

According to the embodiment, through an information theory-based adversarial prompt tuning technique, it is possible to improve the performance of non-native speakers' utterances more efficiently than the existing method of utilizing fine-tuning, and to prevent performance for the native utterance from deteriorating.

In addition, it is possible to implement improved performance for non-native speech by inputting appropriate prompts without updating the model that is trained using native speech and performs well in native speech.

### BRIEF DESCRIPTION OF THE DRAWINGS

FIG. 1 is a configuration diagram of a model training device according to an embodiment.

FIG. 2 is a diagram illustrating a virtual accent feature space according to the present disclosure.

FIG. 3 is a flowchart illustrating a model training method of the model training device according to the embodiment.

FIG. 4 is a configuration diagram illustrating a training operation of an accent module according to the embodiment.

FIG. 5 is a block diagram illustrating a training operation of a prompt generator according to the embodiment.

FIG. 6 is a block diagram of an Automatic Speech Recognition (ASR) apparatus according to the embodiment.

FIG. 7 is a block diagram of a computing device according to an embodiment.

FIGS. 8A, 8B, and 8C are diagrams illustrating latent space visualization showing accent feature extraction according to a simulation of the present disclosure.

FIG. 9 is a diagram illustrating cosine similarity between L1 accent features and L2 accent features obtained by different methods according to simulations of the present disclosure.

### DETAILED DESCRIPTION OF THE EMBODIMENTS

Hereinafter, the present disclosure will be described more fully hereinafter with reference to the accompanying drawings, in which exemplary embodiments of the invention are shown. As those skilled in the art would realize, the described exemplary embodiments may be modified in various different ways, all without departing from the spirit or scope of the present disclosure. Accordingly, the drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

In addition, the terms “ . . . unit”, “ . . . or”, and “module” described in the specification mean units for processing at least one function and operation and may be implemented by hardware components or software components and combinations thereof.

The devices described in the present disclosure are formed of hardware including at least one processor, a memory device, a communication device, and the like, and a program executed in combination with the hardware is stored in a designated place. The hardware has the configuration and performance capable of executing the method of the present disclosure. The program includes instructions implementing the operation method of the present disclosure described with reference to the drawings, and executes the present disclosure in combination with hardware, such as a processor and a memory device.

In the present specification, “transmission or provision” may include not only direct transmission or provision, but also indirect transmission or provision through other devices or by using a detour route.

In the present specification, an expression described in singular may be interpreted as singular or plural unless an explicit expression, such as “one” or “single”, is used.

In the present specification, regardless of the drawings, the same reference numerals refer to the same components, and “and/or” includes each of the mentioned components and all combinations of one or more.

Terms including an ordinal number, such as a first and a second, may be used for describing various constituent elements, but the constituent elements are not limited by the terms. The terms are used only for the purpose of discriminating one constituent element from another constituent element. For example, without departing from the scope of the invention, a first constituent element may be named as a second constituent element, and similarly a second constituent element may be named as a first constituent element.

In the flowchart described with reference to the drawings in the present specification, the order of operations may be changed, several operations may be merged, a certain operation may be divided, and a specific operation may not be performed.

An Artificial Intelligence model (AI model) of the present disclosure is a machine learning model that learns at least one task, and may be implemented as a computer program executed by a processor. The task learned by the artificial intelligence model may refer to a task to be solved through machine learning or a task to be performed through machine learning. The artificial intelligence model may be implemented as a computer program executed on a computing device, downloaded through a network, or sold in a product form. Alternatively, the artificial intelligence model may be interlocked with various devices through a network.

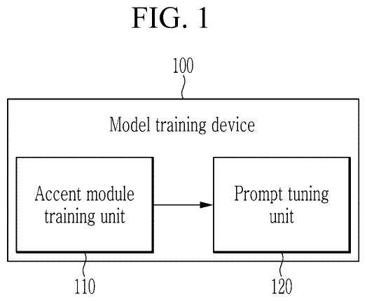

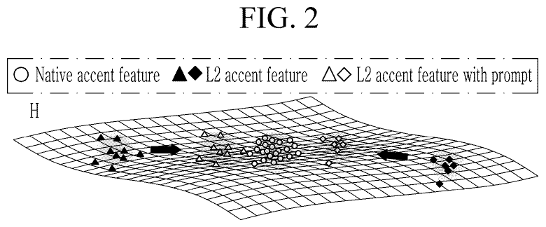

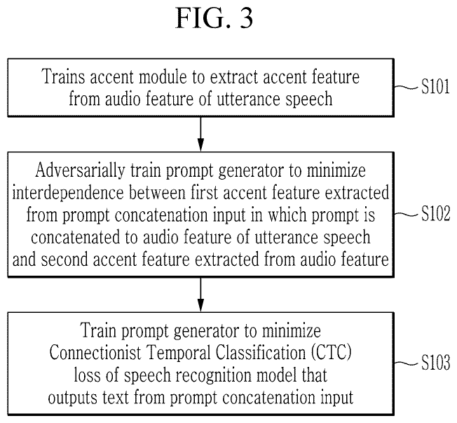

FIG. 1 is a configuration diagram of a model training device according to an embodiment, FIG. 2 is a diagram illustrating a virtual accent feature space according to the present disclosure, and FIG. 3 is a flowchart illustrating a model training method of the model training device according to the embodiment.

Referring to FIG. 1, a model training device 100 is a computing device operated by at least one processor.

The model training device 100 performs Information-Theoretic Adversarial Prompt Tuning (INTapt) that performs information-theoretical adversarial learning while maintaining a backbone weight of a model while introducing a small amount of trainable parameters into an input space.

INTapt aims to introduce auxiliary embedding, that is, prompt, concatenated to an original input. INTapt readjusts attention and applies pre-trained weights to make the corresponding input look like an accented speech that appears during pre-training.

Unlike previous prompts in Natural Language Processing (NLP) or Computer Vision (CV), where one prompt embedding is learned for each discrete task or input domain, an intensity of the accent is continuous. Accordingly, the model training device 100 implements input dependent prompt embedding by training a prompt generator that outputs an input feature prompt.

The model training device 100 does not update the speech recognition model that is trained using the native utterance and shows excellent performance in the native utterance, but performs model training that allows the speech recognition model to show improved performance for non-native utterance by using an appropriate prompt as the input of the speech recognition model.

In this case, since learning of the entire model is not included, it is more efficient than fine-tuning and the model is not updated, so it is possible to maintain performance for native utterance that showed excellent performance.

The model training device 100 trains the prompt generator to generate the prompt for the utterance speech to generate a prompt that the speech recognition model may recognize as intonation of the input utterance is distinguishable from the speaker and closer to the native utterance.

The model training device 100 may include an accent module training unit 110 and a prompt tuning unit 120.

The accent module training unit 110 trains an accent module to obtain an accent characteristic of a specific input speech.

The prompt tuning unit 120 extracts accent features from the utterance in which existing utterance and the prompt are input together to train the prompt generator so that the existing speech and the prompt are distinguishable from each other and the prompt is recognized as being similar to a native accent by well performing speech recognition by the corresponding speech recognition model.

The prompt tuning unit 120 may improve Automatic Speech Recognition (ASR) performance by modulating the attention of the backbone model again to be similar to the accent of the native L1 English speech by training the prompt generator capable of creating a non-native L2 English voice input.

Here, the backbone model is a speech recognition model that generates text from utterance speech. The backbone model may be a self-supervised pre-trained model.

The prompt tuning unit 120 performs adversarial training to reduce accent feature dependence between the original input and the prompt concatenation input.

Here, the original input includes only audio features of the utterance speech to which the prompt is not concatenated.

The prompt concatenation input is an input in which a prompt generated from an audio feature of an utterance speech and an audio feature of the utterance speech are concatenated.

The prompt tuning unit 120 performs training to minimize the Connectionist Temporary Classification (CTC) loss in order to improve the ASR performance for the prompt concatenation input.

The prompt tuning unit 120 introduces auxiliary embeddings concatenated to the original input that may be adaptive to pre-training weights and readjust attention to make the input look like accented utterance during pre-training.

The prompt tuning unit 120 improves the ASR performance of the prompt concatenation input by integrating adversarial training and CTC loss training that minimize mutual information between the accent feature of the original input and the feature obtained by concatenating the prompt embedding in front of the original input.

Referring to FIG. 2, a virtual accent feature space (H) is shown. In essence, the prompt pushes the concatenation accent away from the input accent, indicating that the concatenation is trained to achieve the original CTC loss performance.

The ASR performance at the L2 accent is degraded due to the unique accent function between the native accent feature and the L2 accent feature. INTapt concatenates the prompt to the input space to reduce such a distinction.

Referring to FIG. 3, the accent module training unit 110 trains an accent module AM to extract an accent feature from the audio feature of the utterance speech (S101).

The prompt tuning unit 120 adversarially trains a prompt generator PG to minimize interdependence between a first accent feature extracted from the prompt concatenation input in which the prompt is concatenated to the audio feature of the utterance speech and a second accent feature extracted from the audio feature (S102).

The prompt tuning unit 120 trains the prompt generator to minimize the Connectionist Temporal Classification (CTC) loss of the speech recognition model that outputs text from the prompt concatenation input (S103).

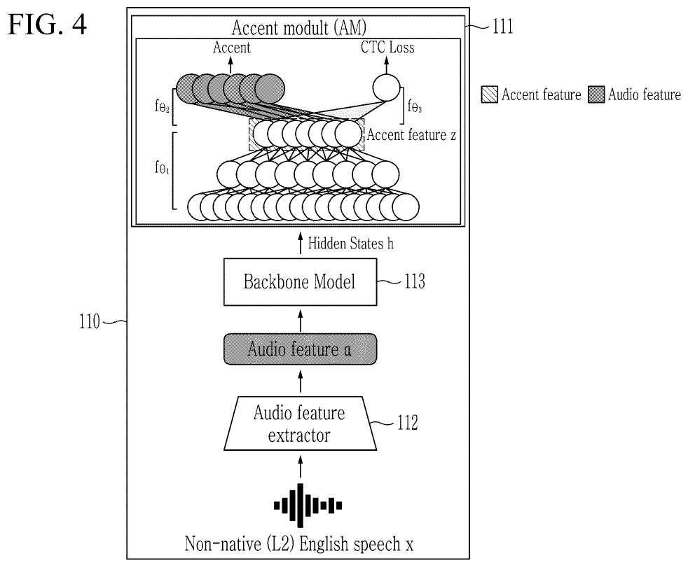

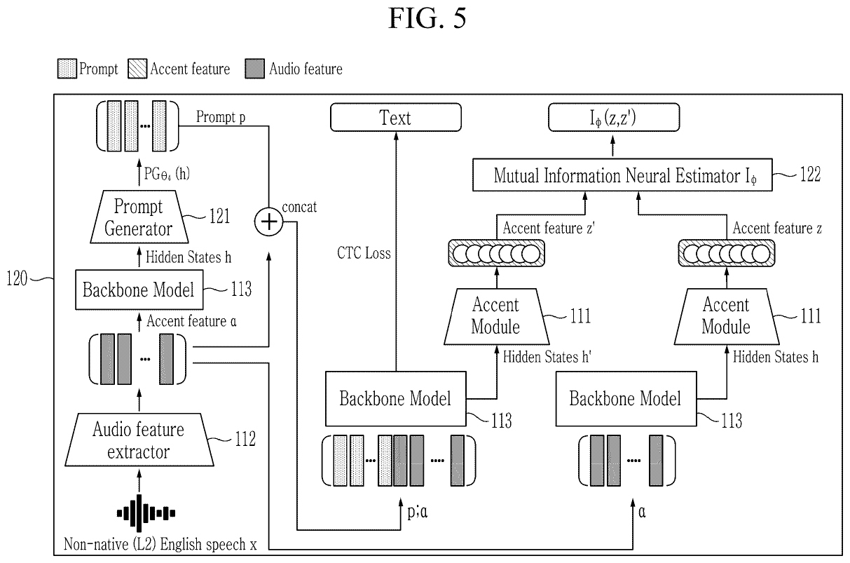

Detailed training operations of the accent module training unit 110 and the prompt tuning unit 120 will be described with reference to FIGS. 4 and 5.

FIG. 4 is a configuration diagram illustrating a training operation of an accent module according to the embodiment, and FIG. 5 is a block diagram illustrating a training operation of the prompt generator according to the embodiment.

Referring to FIG. 4, the accent module training unit 110 acquires an audio feature a of a non-native utterance speech x through the audio feature extractor 112.

The accent module training unit 110 acquires hidden states h by inputting the audio feature a into the backbone model 113.

As described above, the backbone model 113 is a pre-trained speech recognition model.

The accent module training unit 110 trains the accent module 111 to extract the accent feature z by inputting the hidden state h to the accent module 111.

The accent module training unit 110 trains the accent module 111 to capture the accent intensity by predicting the CTC loss by using the accent feature z, and is trained with an accent classification head that isolates the accent feature of a given utterance to train the accent module 111 to extract the accent feature from the audio feature.

Referring to FIG. 5, the prompt tuning unit 120 acquires an audio feature a of a non-native utterance speech x through the audio feature extractor 112.

The prompt tuning unit 120 inputs the audio feature a into the backbone model 113 to obtain a hidden state h.

The prompt tuning unit 120 obtains the prompt p by inputting the hidden state h into the prompt generator (PG) 121.

The prompt tuning unit 120 generates a prompt concatenation input p; a concatenating the prompt p and the audio feature a.

The prompt tuning unit 120 inputs the prompt concatenation input p; a into the backbone model 113 to obtain text and obtain a CTC loss.

In this case, the prompt tuning unit 120 trains the prompt generator 121 to minimize the CTC loss.

The prompt tuning unit 120 acquires a hidden state h′ by inputting the prompt concatenation input p; a into the backbone model 113, and inputs the hidden state h′ into the accent module 111 to acquire a first accent feature z′.

The prompt tuning unit 120 acquires a hidden state h by inputting the audio feature a into the backbone model 113, and acquires a second accent feature z by inputting the hidden state h into the accent module 111.

The prompt tuning unit 120 measures interdependence I_{ø}(z, z′) between the first accent feature z′ and the second accent feature z by inputting the first accent feature z′ and the second accent feature z into a mutual information neural estimator 122.

The prompt tuning unit 120 adversarily trains the prompt generator 121 to minimize interdependence I_{ø} (z, z′).

In FIGS. 4 and 5, the accent module 111 may extract the accent feature z from the input a because the accent module 111 directly accesses the isolated accent feature of the corresponding audio feature input.

The accent module 111 may isolate the accent feature z from the given audio feature a of the input utterance x.

The accent module 111 includes an accent feature extractor f_{θ}_{₁} and an accent intensity regression head f_{θ}_{₃}. The accent feature extractor f_{θ}_{₁} is trained with the accent classification head f_{θ}_{₂} to separate the accent feature to separate the accent feature. The accent intensity regression head f_{θ}_{₃} captures the intensity of the accent as the obtained accent feature.

The accent classification head f_{θ}_{₂} serves to isolate the accent feature of a given utterance.

When the hidden state representation h of the audio feature input a is given, the accent feature extractor f_{θ}_{₁} extracts the accent feature z=f_{θ}_{₁}(h) and the accent classification head f_{θ}_{₂} assigns the accent feature to a correct accent label y.

The intensity of the accent may vary from person to person even when the intensity of the accent belongs to the same L2 group, and may also differ between the utterances of the same speaker. Thus, the accent intensity regression head f_{θ}_{₃} integrates the accent intensity into the accent feature z.

Assuming that the intensity of the accent affects the ASR performance, when the accent intensity regression head f_{θ}_{₃} predicts the CTC loss obtained by inputting the matching speech into the backbone model 113, the accent intensity may be captured by using the extracted accent feature z.

When the batch B is given, the training of the accent module 111 using the accent classification head f_{θ}_{₂} and the accent intensity regression head f_{θ}_{₃} may be summarized by Equation 1.

$${min}_{{θ}_{1} {θ}_{2}} \frac{1}{\vert B \vert} {\sum }_{i ∈ B} - log p ( yi \vert {f}_{{θ}_{2}} ( {f}_{{θ}_{1}} ( hi ) ) ) + λ {min}_{{θ}_{1} , {θ}_{3}} \frac{1}{\vert B \vert} {\sum }_{i ∈ B} {[ {f}_{{θ}_{3}} ( {f}_{{θ}_{1}} ( {h}_{i} ) ) - CTC ( {x}_{i} ) ]}^{2} \qquad [ Equation 1 ]$$

The prompt generator 121 outputs a prompt p for a given audio feature a.

Mutual information between an accent feature z′ obtained using the prompt concatenation input p; a through training of the prompt generator 121 and the accent feature z obtained from the original audio feature a is minimized.

In addition, CTC loss is minimized to improve the ASR performance of the prompt concatenation input p; a through the training of the prompt generator 121.

Prompt tuning is based on the success of prompts in NLP and CV, and may efficiently utilize a pre-trained speech recognition model 113 that has already shown good performance for L1 English speech to improve ASR performance for L2 English speech.

Unlike conventional NLP or CV applications that are trained for each specific task or input domain, a single individual prompt embedding has a continuous intensity of the accent.

To solve this, the prompt generator PG_{θ}_{₄} 121 that generates an input-specific prompt guided by information-theoretical adversarial learning provides input-dependent prompt embedding through training.

More specifically, given a hidden state h=[h₁, h₂, . . . , h_{L}] with a length L, the prompt generator PG_{θ}_{₄} may generate a prompt with a length L′, which is expressed in an equation as Equation 2.

$$p = {PG}_{{θ}_{4}} ( h ) \qquad [ Equation 2 ]$$

Mutual information measures the interdependence between two random variables X and Y. The prior art has proposed a gradient descent-based method for estimating this attribute by using a neural network to estimate mutual information between high-dimensional random variables.

This attribute, that is, interdependence, is estimated by the mutual information neural estimator 122 using a neural network parameterized by Ø as shown in Equation 3.

$$I ( X , Y ) \geq {I}_{∅} ( X , Y ) \qquad [ Equation 3 ]$$

When I_{ø}(X, Y) is maximized, a strict lower limit of original mutual information I(X, Y) is provided.

The prompt tuning unit 120 adversarially trains the prompt generator PG_{θ}_{₄} 121 by using the gradient descent-based method to minimize mutual information between the accent feature of the original L2 utterance input and the prompt concatenation input.

In addition, the prompt tuning unit 120 trains the prompt generator PG_{θ}_{₄} 121 with the aim of minimizing the CTC loss obtained for the prompt concatenation input p; a.

Along with the maximization goal regarding the mutual information neural estimator 122, the two minimization goals regarding the prompt generator PG_{θ}_{₄} 121 are jointly performed in the second training operation, which is represented in Equation 4.

$${min}_{{θ}_{4}} {max}_{∅} \frac{1}{\vert B \vert} {\sum }_{i ∈ B} CTC ( {p}_{{θ}_{4}} ; a ) + λ {I}_{∅} ( {z}_{{θ}_{4}}^{′} , z ) \qquad [ Equation 4 ]$$

In FIGS. 4 and 5, the accent module 111, the prompt generator 121, and the mutual information neural estimator 122 are trainable models.

In addition, the backbone model 113 of FIGS. 4 and 5, the audio feature extractor 112 of FIGS. 4 and 5, and the accent module 111 used in FIG. 5 are pre-trained models.

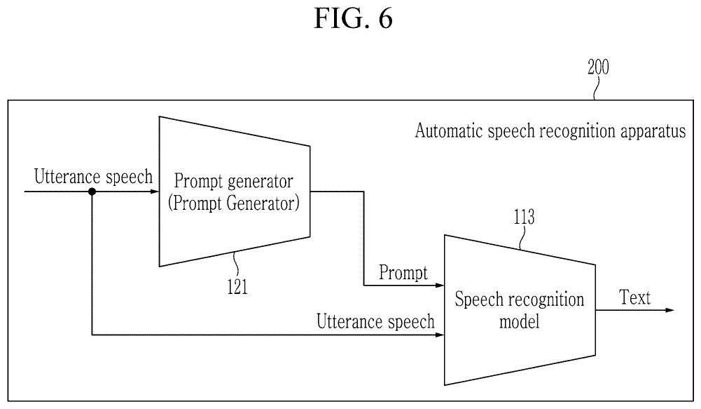

FIG. 6 is a block diagram of an Automatic Speech Recognition (ASR) apparatus according to the embodiment.

Referring to FIG. 6, an ASR device 200 is a computing device operated by at least one processor.

The ASR device 200 recognizes an utterance speech and outputs text corresponding to the utterance speech.

The ASR device 200 includes a prompt generator 121 and a speech recognition model 113.

In this case, the speech recognition model 112 is a model trained with native utterance data, and the prompt generator 121 is a model trained using non-native utterance speech.

As described in FIGS. 1 to 5, the prompt generator 121 is trained to receive an utterance speech and generate a prompt corresponding to the utterance speech.

In this case, the prompt generator 121 generates a prompt so that the speech recognition model 112 is capable of recognizing the accent of the input utterance as the input utterance is distinguishable from the corresponding speaker and is close to the native utterance.

The speech recognition model 113 outputs text corresponding to the utterance speech from the prompt concatenation input concatenating the utterance speech and the prompt.

It is shown that in Sections 3.2 and 4, the aforementioned goal is not only to improve the ASR performance of L2 speech, but also effectively make the input similar to the accent features of L1 speech.

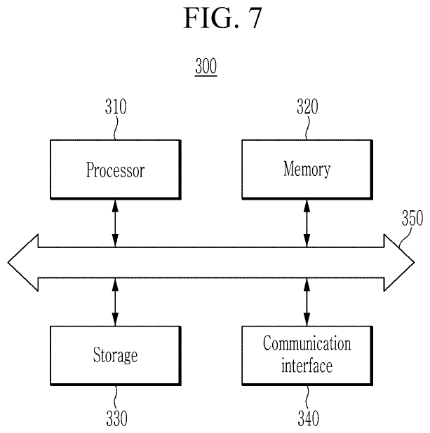

FIG. 7 is a block diagram of a computing device according to an embodiment.

Referring to FIG. 7, the model training device 100, the audio feature extractor 112, the accent module 111, the prompt generator 121, the mutual information neural estimator 122, and the automatic speech recognition apparatus 200 described with reference to FIGS. 1 to 6 may be implemented as a computing device 300 operated by at least one processor.

The computing device 300 may include one or more processors 310, a memory 330 for loading a computer program performed by the processor 310, a storage device 350 for storing a computer program and various data, a communication interface 370, and a bus 390 for concatenating the same. In addition, the computing device 300 may further include various components. The processor 310 is a device for controlling the operation of the computing device 300, and may be a processor of various forms that process instructions included in a computer program, and may include, for example, at least one of a Central Processing Unit (CPU), a Micro Processor Unit (MPU), a Micro Controller Unit (MCU), a Graphic Processing Unit (GPU), or any type of processor well known in the technical field of the present disclosure.

The memory 330 stores various types of data, instructions, and/or information. The memory 330 may load the corresponding computer program from the storage device 350 such that instructions described to execute the operation of the present disclosure are processed by the processor 310. The memory 330 may be, for example, a read only memory (ROM), a random access memory (RAM), etc.

The storage device 350 may non-temporarily store computer programs and various types of data. The storage device 350 may include a nonvolatile memory, such as a Read Only Memory (ROM), an Erasable Programmable ROM (EPROM), an Electrically Erasable Programmable ROM (EEPROM), a flash memory or the like, a hard disk, a removable disk, or any type of computer-readable recording medium well known in the art to which the present disclosure pertains.

The communication interface 370 may be a wired/wireless communication module supporting wired/wireless communication.

The bus 390 provides a communication function between components of the computing device 300.

The computer program includes instructions executed by the processor 310, is stored in a non-transitory computer readable storage medium, and instructions cause the processor 310 to execute the operation of the present disclosure. Computer programs may be downloaded over a network or sold in a product form.

The computer program may include instructions for executing the training operations of FIGS. 1, 4, and 5 in operations of FIG. 3.

Hereinafter, the present disclosure will be described in detail through experimental examples. These experimental examples are for illustrative purposes only, and the present disclosure is not limited thereto.

### Experimental Example

### Dataset

The dataset was L2 English utterances, with a non-native utterance corpus consisting of Mandarin (ZH), Hindi (HI), Vietnamese (VI), Korean (KO), Spanish (ES), and Arabic (AR).

Each L2 group consists of two male speakers and two female speakers, who read the same 1132 texts. The training/development/test (train/dev/test) set is configured to divide the data by 0.8/0.1/0.1 so that they do not overlap each other.

In addition, training data is randomly divided into more frequent accents (MFAs) (ZH, HI), less frequent accents (LFAs) (VI, KO), and hidden accents (UA) (ES, AR) to simulate natural data collection situations in which the amount of data varies by group.

For MFA, all training data is maintained, for LFA, half of the data is maintained, and for UA, all training data is removed.

The hidden state representation obtained in the third layer of the backbone model is used as input to the accent module and the prompt generator for both HUBERT_{large} and HUBERT_{XLarge}.

The dimension of the accent feature a was set to d=256 the prompt length L′ was set to 40, and the dimensions of the prompts were set to 1024 and 1280 which are the same as the input embedding sizes of HuBERT_{large} and HuBERT_{XLarge}, respectively.

For all trainable models (accent modules, prompt generators, MINE, fine-tuned backbone), a weight-decay λ=0.005 with different training ratios and an AdamW optimizer with β₁=0.9, β₂=0.999, ϵ=1e−8 are used.

The training ratios used for both AM and MINE are 1e-3, and the training ratios used for Fintune, prompt_{ctc}, and INTapt are 5e-6, 1e-4, and 1e-4, respectively.

In all methods, the batch size is set to 16 for HuBERT_{large} and 8 for HuBERT_{Xlarge}.

In the foregoing, λ=0.5 was used in Equation 1 and 2=0.003 was used in Equation 4. The best model is selected through the lowest WER in the verification set. All experiments were performed on the NVIDIA Quadro RTX 8000.

### Accent Feature Isolation

Whether the features contain information other than the accent is verified by visually analyzing the accent features extracted from AM.

The two-dimensional representation of the extracted accent features are plotted by using t-SNE (vander Maaten and Hinton, 2008) with gender labels for three groups of L2 (i.e., HI, KO, ES).

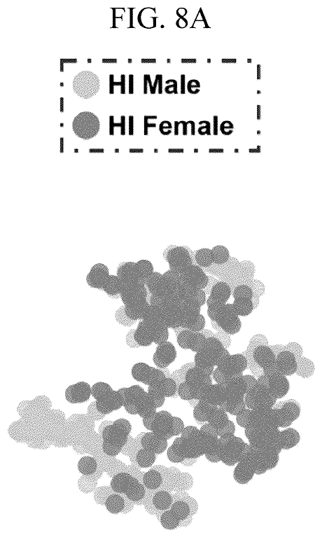

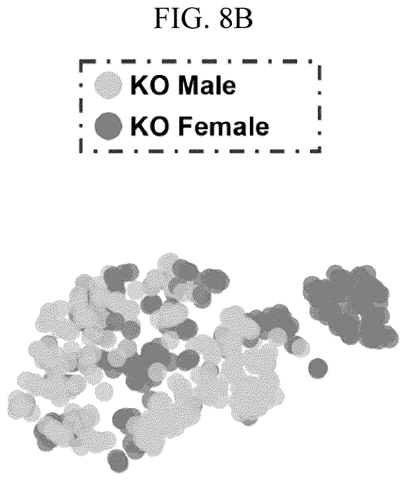

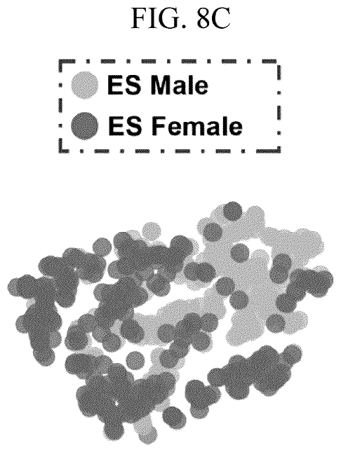

FIGS. 8A, 8B, and 8C illustrate a latent space visualization showing an accent feature extraction according to a simulation of the present disclosure.

In this case, FIG. 8A is an example of using non-native speech corpus of HI Male and HI Female speaking Hindi, FIG. 8B is an example of using non-native speech corpus of KO Male and KO Female speaking Korean, and FIG. 8C is an example of using non-native speech corpus of ES Male and ES Female speaking Spanish.

According to FIGS. 8A, 8B, and 8C, it is shown that the variance point is clear between the L2 groups, but it is difficult to distinguish between genders. This means that AM successfully separated the accent function from the audio.

### Models

For pre-trained backbone speech models, two different settings: HuBERT_{Large} and HuBERT_{XLarge}, are attempted.

Three different training simulations are considered.

For the first simulation, Finetune uses a standard fine-tuning method that updates pre-trained model weights to minimize CTC losses.

For the second simulation, Prompt_{ctc} trains prompt generators without minimizing mutual information.

In the case of the third simulation, INTapt trains a prompt generator having the goal proposed in Equation 4.

INTapt's accent feature extractor uses three-layer multi-layer perceptron (MLP), the accent classification head uses one-layer MLP, and the accent intensity regression head uses three-layer MLP. INTapt's prompt generator consists of a single-layer transformer.

Since the transformer structure of the prompt generator has been adopted, the maximum output length is equal to the length L of the input audio feature a.

A specific length of the prompt may be set by fetching the first L′ output embeddings from the front of the transformer output.

For the Mutual Information Neural Estimator (MINE), a three-layer MLP is also used.

### Results

### Table

Table 1 shows the Word Error Rate (WER) of various L2 groups for ASR tasks.

TABLE 1

| | | | MFA | | LFA | | UA | | |
|---|---|---|---|---|---|---|---|---|---|
| Backbone | #.params | Methods | ZH | HI | VI | KO | ES | AR | ALL |
| HUBERT_{Large} | — | Backbone | 18.71 | 8.80 | 25.8 | 10.98 | 14.12 | 14.92 | 15.55 |
| | 315M | +Finetune | 15.46 | 7.91 | 22.26 | 9.95 | 14.19 | 13.94 | 13.95 |
| | 12.5M | +Prompt_{ctc} | 13.93 | 7.20 | 21.93 | 9.69 | 12.64 | 12.38 | 12.96 |
| | 12.9M | +INTapt | 13.09 | 6.64 | 21.25 | 8.97 | 12.18 | 11.92 | 12.34 |
| HUBERT_{X Large} | — | Backbone | 17.03 | 7.48 | 26.02 | 10.49 | 13.65 | 13.52 | 14.69 |
| | 958M | +Finetune | 15.49 | 7.53 | 24.09 | 10.02 | 13.48 | 12.56 | 13.86 |
| | 19.7M | +Prompt_{ctc} | 13.02 | 7.31 | 19.26 | 8.05 | 10.46 | 10.38 | 11.41 |
| | 19.9M | +INTapt | 11.67 | 6.63 | 18.41 | 7.17 | 10.44 | 10.55 | 11.00 |

In Table 1, ‘#.params’ indicates the number of parameters updated for training.

Table 1 shows the comparison of WER (%) for the generated subsets of L2-ARCTIC (MFA, LFA, UA), and the lower the WER (%), the better the performance.

According to Table 1, INTapt obtained 12.34% for HuBERT_{Large} and 11.00% for HuBERT_{XLarge} in all aggregated utterances, showing the lowest WER across all L2 groups, and exhibiting excellent performance with 1.62% p and 2.86% p over Finetuned, respectively. Thus, it was found that the performance improvement of the prompt tuning approach (Prompt_{ctc} and INTapt) is more significant compared to standard fine-tuning, despite updating a small number of parameters (2-4%). This is consistent with previous research results that larger model sizes may achieve more advantages through prompt tuning methods.

Table 2 shows the WERs for LibriSpeech (Panayotov et al., 2015) test-clean, and test-other, which consist mainly of L1 speech.

TABLE 2

| Methods | test-clean | test-other | test-all |
|---|---|---|---|
| Backbone | 2.15 | 4.42 | 3.29 |
| +Finetune | 8.10 | 10.08 | 9.10 |
| +Prompt_{ctc} | 2.56 | 4.93 | 3.77 |
| +INTapt | 2.41 | 4.94 | 3.66 |

In Table 2, ‘test-all’ represents the set of ‘test-clean’ and ‘test-other’.

According to Table 2, compared to the backbone model, after fine-tuning, the WER increased by 5.81% p, but since Prompt_{ctc} and INTapt did not change the backbone weight, the WER of test-all only increased by 0.48% p and 0.37% p, respectively. This represents one of the main advantages of the prompt tuning method in that it slightly degrades the performance of the backbone model for already outstanding tasks while improving the performance of other tasks.

TABLE 3

| | | | | | | | Unseen | | |
|---|---|---|---|---|---|---|---|---|---|
| | | | MRA | | LEA | | Accent | | |
| Backbone | #.params | Methods | ZH | HI | VI | KO | ES | AR | Avg. |
| HUBERT_{Large} | 315M | +Finetune | 0.31 | 0.70 | 0.58 | 0.50 | 0.73 | 0.38 | 0.36 |
| | 12.5M | +Prompt_{ctc} | 0.51 | 0.56 | 0.99 | 0.74 | 0.78 | 0.38 | 0.30 |
| | 12.9M | +INTapt | 0.66 | 0.72 | 0.73 | 0.69 | 0.59 | 0.27 | 0.13 |
| HUBERT_{X Large} | 958M | +Finetune | 0.41 | 0.21 | 1.79 | 0.06 | 0.33 | 0.12 | 0.29 |
| | 19.7M | +Prompt_{ctc} | 0.15 | 0.64 | 0.19 | 0.51 | 0.24 | 0.56 | 0.12 |
| | 19.9M | +INTapt | 0.33 | 0.31 | 0.41 | 0.30 | 0.25 | 0.12 | 0.18 |

The standard deviation values for the experimental results in Table 1 are shown, which were obtained by performing the same experiment by using five different random seeds.

Table 3 reports the standard deviations of the results in Table 1 using five different random seeds, and the backbone experiment in Table 1 was obtained without training, so standard deviations for this are not included.

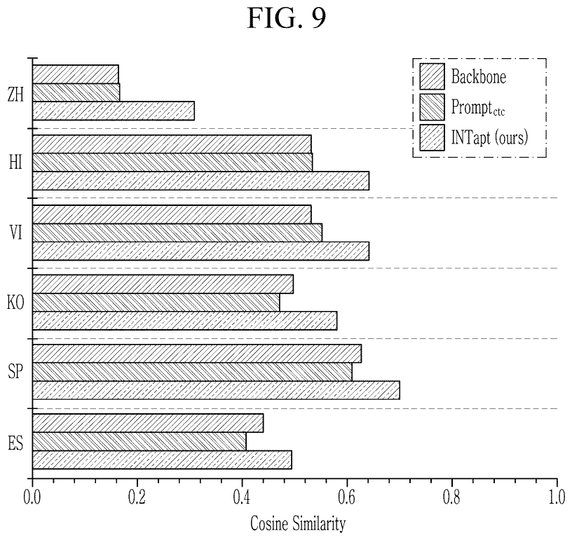

FIG. 9 is a diagram illustrating cosine similarity between L1 accent features and L2 accent features obtained by different methods according to simulations of the present disclosure.

According to FIG. 9, it represents a result of analyzing whether INTapt allows the L2 speech input to be similar to the accent of the L1 speech.

The L1 accent function and the L2 accent function obtained by using the Backbone model, Prompt_{ctc}, and INTapt are extracted by using the accent module.

INTapt shows the highest cosine similarity for all L2 groups. This means that INTapt effectively adjusts the attention of the pre-trained model, so that L2 speech is similar to L1 speech in terms of accents.

By introducing Information Theoretic Adversarial Prompt Tuning (INTapt) to improve non-native ASR performance, INTapt may readjust the attention of the pre-trained speech model by concatenating the input-dependent prompt embedding to the original input without updating the model weight. Throughout the simulation, it is shown that INTapt is superior to the standard fine-tuning of the pre-trained model for L2 speech without degrading the L1 speech by allowing the L2 input to be similar to the L1 accent.

Through extensive experiments above, it was confirmed that the proposed dual goals of INTapt not only leads to better performance for L2 English accents, but also leads to higher similarity between the accent features of the prompt concatenation input and the accent features of the L1 English accent.

According to the above description, it was confirmed that it is more efficient in terms of time and learning parameters than speech recognition of non-native speakers based on existing fine-tuning, and the performance improvement for non-native speakers is superior. In addition, unlike existing techniques, there is an advantage in that the performance of native speakers' speech is maintained. Through this, it is possible to efficiently and effectively expand the existing speech recognition system that exhibits excellent performance in the native speakers' speech to various speakers. Therefore, it may be usefully used for generalization not only of non-native speakers but also of age, education level, and furthermore, speech with speech impairment.

The exemplary embodiments of the present disclosure described above are not only implemented through the apparatus and method, but may also be implemented through programs that realize functions corresponding to the configurations of the exemplary embodiment of the present disclosure, or through recording media on which the programs are recorded.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

What is claimed is:

1. A model training device operated by at least one processor, the model training device comprising:
an accent module trained to extract an accent feature from an audio feature of an utterance speech; and
a prompt generator for extracting a first accent feature from a prompt concatenation input that concatenates the prompt to the audio feature, and a second accent feature from the audio feature by using the accent module, and being adversarially trained to minimize interdependence between the first accent feature and the second accent feature to generate a prompt from the audio feature.

2. The model training device of claim 1, wherein:
the prompt generator is trained to minimize a Connectionist Temporary Classification (CTC) loss of a speech recognition model that outputs text from the prompt concatenation input.

3. The model training device of claim 2, wherein:
the accent module includes:
an accent feature extractor that is trained with an accent classification head that isolates an accent feature of a given speech and extracts the accent feature from the audio feature; and
an accent intensity regression head for predicting the CTC loss to capture an accent intensity by using the accent feature extracted by the accent feature extractor.

4. The model training device of claim 3, wherein:
the accent feature extractor extracts the accent feature from a hidden state of the audio feature acquired through the speech recognition model.

5. The model training device of claim 4, further comprising:
a mutual information neural estimator that estimates the interdependence by using a neural network.

6. The model training device of claim 2, wherein:
the speech recognition model is a model trained by using native utterance data, and
the utterance speech used for training the accent module and the prompt generator is a non-native utterance speech.

7. A method of operating a model training device operated by at least one processor, the method comprising:
training an accent module to extract an accent feature from an audio feature of an utterance speech;
extracting a first accent feature from a prompt concatenation input that concatenates the prompt to the audio feature, and a second accent feature from the audio feature by using the accent module; and
adversarially training a prompt generator that generates a prompt from the audio feature to minimize interdependence between the first accent feature and the second accent feature.

8. The method of claim 7, further comprising:
training the prompt generator to minimize a Connectionist Temporary Classification (CTC) loss of a speech recognition model that outputs text from the prompt concatenation input.

9. The method of claim 8, wherein:
the training of the prompt generator includes:
obtaining a hidden state by inputting the audio feature into the speech recognition model;
obtaining the prompt by inputting the hidden state into the prompt generator;
generating the prompt concatenation input by concatenating the audio feature and the prompt;
inputting the prompt concatenation input into the speech recognition model to obtain the CTC loss; and
training the prompt generator to minimize the CTC loss.

10. The method of claim 9, wherein:
the extracting includes:
obtaining a first hidden state by inputting the prompt concatenation input to the speech recognition model, and obtaining a second hidden state by inputting the audio feature to the speech recognition model; and
extracting the first accent feature by inputting the first hidden state into the accent module, and extracting the second accent feature by inputting the second hidden state into the accent module.

11. The method of claim 10, wherein:
the adversarially training includes
measuring the interdependence by using a mutual information neural estimator based on a neural network model.

12. The method of claim 10, wherein:
the training of the accent module includes:
training the accent module to extract an accent feature from the hidden state of the audio feature acquired through the speech recognition model, and to predict the CTC loss using the extracted accent feature and capture the accent strength; and
train the accent module to extract the accent feature from the audio feature by being trained with an accent classification head that isolates the accent feature of a given speech.

13. An automatic speech recognition apparatus operated by at least one processor, the automatic speech recognition apparatus comprising:
a prompt generator for generating a prompt from an accent feature, which is a state hidden in an audio feature of an utterance speech; and
a speech recognition model for generating text for the utterance speech from a prompt concatenation input that concatenates the audio feature and the prompt.

14. of claim 12, wherein:
the prompt generator is adversarially trained to minimize interdependence between a first accent feature extracted from the prompt concatenation input that concatenates the prompt to the audio feature of the utterance speech and a second accent feature extracted from the audio feature.

15. of claim 14, wherein:
the prompt generator is trained to minimize Connectionist Temporal Classification (CTC) loss of a speech recognition model that outputs text from the prompt concatenation input.
